(19) United States
(12) Patent Application Publication
(10) Pub. No.: US 2003/0089209 A1
(43) Pub. Date: May 15, 2003

(54) Device for cutting paper webs

(76) Inventors: Dieter Brueckel, Kaufbeuren (DE); Helmut Eichelberg, Donauwoerth (DE); Otto Hartmann, Zusmarshausen (DE)

Correspondence Address: BEYER WEAVER & THOMAS LLP, P.O. BOX 778, BERKELEY, CA, 94704-0778, US

(21) Appl. No.: 10/220,647

(22) PCT Filed: Mar. 2, 2001
(86) PCT No.: PCT/EP01/02380

(30) Foreign Application Priority Data
Mar. 7, 2000 (DE) 100-11-006.1

(51) Int. Cl. B26D 5/00; B26D 7/06

(52) U.S. Cl. 83/76.6; 83/402; 83/403.1; 83/360; 83/367; 83/438

(57) ABSTRACT

An apparatus for cutting paper webs includes a paper feeding means (102), a cutting means (108) and a paper delay means (106) which is arranged between the paper feeding means (102) and the cutting means (108) and delays the paper web (112), which is being fed, in such a manner that a position where the cutting means (108) cuts the paper web (112) is determined on the paper web (112). A buffer means (104) is arranged between the paper feeding means (102) and the paper delay means (106) so as to receive an accumulating length of the paper web (112) in the form of a loop during the delay of the paper web (112). A control means (190) controls the paper feeding means (102) and the paper delay means (106) in such a manner that the loop (195) received in the buffer means (104) does not fall short of a minimum height (h).

### BACKGROUND OF THE INVENTION

1. Field of the Invention

The present invention relates to an apparatus for cutting paper webs. In particular, the present invention relates to an apparatus for cutting paper webs which forms part of a complex paper handling system.

2. Description of the Related Art

Paper handling systems are employed mainly by large enterprises, banks, insurance companies, service providers etc. In these enterprises, paper handling systems serve to process large amounts of paper, such as invoices, reminders, bank statements, insurance policies or checks. The individual sheets of paper to be handled by such a paper handling system are produced, in many cases, by high-speed printers printing letters, forms etc. onto a paper web. This paper web is typically fed to the printer from a large supply roll and is fed to the paper handling system after printing. However, before the paper handling system can carry out the corresponding operations for compiling individual sheets of paper etc., it is necessary for the paper web printed upon by the high-speed printer to be cut so that individual sheets are fed to the paper handling system. To this end, cutting machines are used which comprise a knife or a different type of cutting apparatus, the paper web to be cut being fed to the knife by a paper feeding means. These paper handling systems are frequently designed such that handling different papers having different formats is made possible. This flexibility exhibited by the paper handling system with regard to the formats used requires that paper webs can be cut in different formats.

Another important aspect about paper handling systems is that different numbers of papers are required for respective processes, depending on controlling these handling systems, which means that, for example, five further pages are enclosed with a certain letter, whereas another letter may need only one additional page to be added to it. So as to insure feeding at different rates it is required that the cutting machine, too, is able not only to cut different formats but also to feed them to the paper handling system at different speeds.

The cutting systems mentioned above, which represent part of a complex paper handling system, therefore in principle meet different requirements than so-called rotary cutting machines such as are employed, for example, at printing works in the production of daily newspapers. Such rotary cutting machines merely serve to cut paper webs in a predetermined format. By specifying only one format it is possible, with these machines, to drive the paper web to the rotary knife at a constant speed, the driving speed being established depending on the preset format and the rotational speed of the rotary knife. A switchover to another format is associated with a considerable expense in such rotary cutting machines, since the driving speed of the rotary knife and the feeding speed of the paper web must be set depending on the new format. Setting the respective parameters to a new format in an automatic manner requires a considerable regulatory expense in such rotary cutting machines.

In addition to the systems described above, in the prior art cutting machines are known in which the paper web is advanced by a desired cutting length l, by means of a drive, over the cutting edge of a transverse cutting means, which may be formed by a lifting or rotary knife, and is held in the cutting position. While the paper is now stopped at the cutting position, the transverse cutting apparatus cuts off the paper advanced over the cutting edge. So as to obtain a high throughput (cuts per hour), the paper web must be advanced by the cutting length within as little time as possible, so that the paper web is again stopped at the desired cutting position. To achieve this, the paper web must be accelerated to a maximum speed Vₘₐₓ within as little time as possible and be decelerated again so that by standstill the paper web has been advanced precisely by the cutting length l.

The disadvantage of this approach is that this very fast acceleration and the very high maximum speed cause a very irregular movement of the paper web during feeding into the machine. Furthermore, this leads to the fact that during paper feeding flaws occur due to a crease formation, or that even a tearing of the paper web occurs. This is why the maximum possible acceleration and the maximum possible speed are limited. FIG. 5 describes such a cutting machine in further detail.

The cutting machine 500 includes a paper feeding means 502 driven by means of a motor 502a. As can be seen in FIG. 5A, the paper feeding means 502 includes a first drive roll 504 driven by the motor 502a at a speed V₁. A feeding element, preferably in the form of a feeding belt 508 or a feeding chain, is guided through the drive roll 504 and a guiding roll 506. A paper web 512 extends from a supply area 510 via a diverting and guiding means 514 to the feeding means 502.

In the cutting machine represented in FIG. 5A, the paper web 512 is provided with a perforated edge in which equally spaced holes are provided for guiding and driving the paper web. To ensure the drive and guidance of the paper web 512, the guiding belt 508 of the feeding means 502 comprises a plurality of teeth 508a engaging with the holes in the perforated edge of the paper web 512. The paper web 512 is fed to a cutting means 516 by means of the feeding means 502. The cutting means 516 includes a so-called falling knife 518 having substantially the form of a guillotine. This falling knife is moveably guided between two guides 520, 522. The cutting means further includes a counterblade 524 which is passed by the falling knife 518 in a direction perpendicular to the paper web 512 during its cutting movement. The falling knife 518 is actuated by means of a motor 526 driving, for example, a belt drive, which consists of a drive roll 528a, a guiding roll 528b and a belt 530, at a speed V₂. One end of a connecting rod 532, the opposite end of which is connected to the falling knife 518, is attached at an eccentric position of the guiding roll 528b. In cooperation of the drive 526, the connecting rod 532 and the guides 520, 522, the falling knife carries out a continuous upward and downward movement when driven by the motor 526. A paper removal means 534 is provided downstream of the cutting means 516 in the paper conveying direction, the paper removal means 534 serving to move the cut pieces of paper further. This paper removal means includes a drive roll 538 actuated by a motor 536. The motor 536 drives the drive roll 538 at a constant speed V₃. In general, the speed V₃ of the drive roll 538 is higher than the feeding speed of the paper web 512 so that a secure removal of the cut papers is ensured. In addition to the drive roll 538 the paper removal means 534 includes a guiding roll 540, the papers cut moving between the driving roll 538 and the guiding roll 540. The guiding roll 540 is biased, by a spring 542, such that it is pressed against the paper and against the drive roll 538.

The fundamental operation of the cutting machine described in FIG. 5A will be explained in more detail below with reference to the diagrams represented in FIGS. 5B and 5C.

At a time t=0 the motor 502a is driven so as to drive the feeding means 502 so that the paper is accelerated to a speed V₁. At a time t₁ the predetermined speed V₁ has been reached and is maintained up to a time t₂. Upon reaching the time t₂, a position of the paper web 512, in which cutting is to be carried out, is already near the cutting means 516. The drive operation of the feeding means is controlled such that the paper web 512 is decelerated as of time t₂ so that same is stopped at a time t₃. As soon as the time t₃ is reached, the motor 526 is driven and accelerated to the speed V₂ which is reached by a time t₄. This speed is maintained up to a time t₅, and the speed is reduced to zero by a time t₆. During the course of time from t₃ to t₆, the cutting movement of the falling knife 518 is effected by the up and down movement of the connecting rod 532, and the paper web is cut at the desired position. The paper removal means 534 which is constantly driven by the motor 538 at the speed V₃ ensures that the paper cut is conveyed further. As soon as the time t₆ is reached, the control of speeds which has been described with reference to FIGS. 5B and 5C is started anew, and the paper web 512 is fed further in the direction of the cutting apparatus 516 until the respective cutting position on the paper web 512 is reached.

Cutting outputs of up to 19,000 standard forms per hour, or cuts per hour, with the resulting format having dimensions of 304.8 mm×210 mm, can be achieved with the cutting machines described with reference to FIG. 5A.

One disadvantage of the cutting machine described with reference to FIG. 5A is that its operation requires a large mass, that is to say the paper web, to be accelerated constantly. This constant acceleration and deceleration of the paper web enables no continuous operation. This constant accelerating and decelerating results in a considerable reduction in the life of the components used, in particular of the motors 502a, 526 employed. The achievable accelerations and/or delays, and therefore the achievable cutting outputs, are also limited by the fact that too much acceleration causes the guiding hole edges to tear and/or the paper web to tear when using a transversely perforated material. Further, jerky acceleration of the paper mass fed leads to a high noise emission.

A further problem that these known cutting machines exhibit is that there is no suitability for a so-called on-line operation due to the low paper conveying speed which is limited by a constant acceleration and deceleration. The term on-line operation here refers to a mode of operation wherein a high-speed printer is fed a paper web, wherein same is printed upon and is fed directly to the cutting machine at the speed of the printer.

In the prior art cutting machines, a supply stack 510 is thus provided into which paper webs, the printing of which has been completed, are introduced from a remotely arranged printer, and from where they are fed to the cutting machine. The low paper conveying speed further results in an upper limit of the performance of such known cutting machines, which performance amounts to the above-mentioned approximately 19,000 standard forms per hour or cuts per hour that are achieved with currently known machines, the resulting format having dimensions of 304.8 mm×210 mm.

A further reason for the above-mentioned limitation in the performance of these known machines is that outputs of more than 19,000 cuts per hour lead to chaotic appearances of the paper web which are caused by the constant acceleration and deceleration and cannot be suppressed or controlled by means of technology.

The prior art has already known paper handling systems which continuously feed a paper web to be cut to a knife without stopping the paper web during cutting of same.

DE-OS 2165194 relates to a method and an apparatus for feeding material to sheet-treatment and sheet-processing machines. By means of a pulling force a web of material is fed to a knife cylinder from a material roll. The cutting of the material web is effected such that the material web is retained at the knife cylinder by means of suction means upon reaching the knife cylinder, that initially a so-called waste strip is cut off, and that the thus created leading edge of the material web, which continues to be retained by the suction means, is passed on to a guiding cylinder by rotating the knife cylinder. The leading edge of the material web is retained at the guiding cylinder in a further rotation of the cylinder, and is conveyed at the speed of the web until the material web reaches a cutting area where a sheet is cut off by the knife. A loop is created between the material roll and the knife during operation, which loop builds up during the cutting process and is reduced again after cutting.

DE-PS-723878 relates to a conveying means for webs, in particular paper webs, to transverse cutters and folding machines. A paper web is uniformly fed to a knife via rolls, a suction stamp being arranged between the knife and the rolls, which suction stamp retains the paper web so that no further conveyance of paper is effected in the direction of the knife. On account of the steadily fed paper, this retention effect leads to the formation of a loop.

The paper handling systems described above, which, during the cutting process, continuously feed a paper web to be cut, however, exhibit a significant problem with regard to the cutting accuracy as soon as the speed of paper feeding exceeds a certain value. It has been found that the cutting accuracy, the tolerances of which are in the area of tenths of millimeters, depends on the formation of the paper loop. As of a paper feeding speed of more than 0.8 m/s, the loop exhibits a behavior which is no longer reproducible. This behavior of the loop, which is no longer reproducible, leads to unacceptable variations in the cutting accuracy.

Other cutting machines known in the prior art, which are described, for example, in DE 196 24 277, include a buffer means which is arranged between a paper feeding means and a cutting means and which receives the length of the paper web accumulated during the delay of the paper web, and simultaneously controls the formation of a loop of the accumulated paper web and damps the oscillations of the loop, and leads to a reproducible loop behavior.

The disadvantage of this apparatus which has just been described is that the loop is stretched at a high speed during the forward-feed phase, so that the acoustic shocks cannot be avoided despite the damping. In addition, each of these stretchings represents a considerable mechanical stress upon the paper web which is disadvantageous in that it holds the risk of the paper web tearing or leads to a crease formation, which causes problems with feeding the paper web.

### SUMMARY OF THE INVENTION

It is the object of the present invention to provide an improved apparatus for cutting paper webs which exhibits high performance, may be realized in a simple and cost-efficient manner, exhibits a high cutting accuracy at high paper feeding speeds and reduces the mechanical stress upon the paper web.

The present invention is an apparatus for cutting paper webs. The apparatus includes a paper feeder, a cutter, a paper delayer which is arranged between the paper feeder and the cutter and delays the paper web, which has been fed, in such a manner that a position where the cutter cuts the paper web is determined on the paper web, a buffer arranged between the paper feeder and the paper delayer so as to receive, during the delay of the paper web, an accumulating length of the paper web in the form of a loop, and a controller, wherein the controller controls the paper feeder and the paper delayer such that the loop received in the buffer does not fall short of a minimum height, and wherein the paper delayer is a paper conveyer arranged between the buffer and the cutter and is controllable so as to stop or delay the paper web.

Generally speaking, the present invention relates to a method for cutting a continuous paper web with and without transport hole edges, wherein the paper web is advanced by a cutting length l over the cutting edge of a transverse cutting means and is held in this position for the duration of cutting. The paper webs to be processed are either present in a pre-folded manner as a stack, are unwound from a roll or are supplied on-line from a printer.

The inventive apparatus decouples the high dynamics of the paper forward feed for cutting from the paper feeding in the machine and therefore allows a higher acceleration and maximum speed in the forward-feeding of the paper web into the cutting position within the machine at a significantly lower acceleration and minimum speed in the feeding of the paper web into the machine. If the apparatus is operated in continuous operation, which may be characterized by a continuous sequence of advancing and cutting, a nearly continuous paper inflow may be achieved. Due to the fact that the loop is never fully eliminated, i.e. that a stretching of the paper is avoided, it is further ensured that no unnecessary mechanical stresses are exerted on the paper by the stretching during the forward-feed phase, so that the risk of flaws due to a tearing or creasing of the paper web is reduced.

One advantage of the present invention is that the above-described flaws, such as, for example, the crease formation or tearing of the paper web, are reduced further by reducing the dynamics of the movement of the paper web during the feeding of paper into the machine. Another advantage is that the development of noise on the part of the paper web fed is reduced due to the avoidance of fully stretching the paper web in the forward-feed phase.

Another advantage of the present invention is that a feeding of the paper web is possible at an substantially constant speed if the paper web undergoes a short-term delay for specifying the position where cutting is to be effected.

The advantage of the present invention is that a constant acceleration and deceleration of the paper web is no longer necessary due to the uniform feeding speed of the paper web, so that a constant switching on/off of the motors can be dispensed with, which leads to a significant increase in the life of these motors and of the other components.

Another advantage of the present invention is that the apparatus in accordance with the present invention may be run at double the paper conveying speed as against the paper conveying speed in machines from the prior art. This leads to a doubling of the performance, which is at 24,000 cuts per hour in inventive apparatuses.

Still another advantage of the present invention is that due to the feeding of the paper web at a constant speed, the inventive apparatus may be run at a continuous operation, which means that the apparatus may directly follow the output of a high-speed printer, so that the paper web need not be relocated and temporarily stored.

### BRIEF DESCRIPTION OF THE DRAWINGS

Preferred embodiments of the present invention will be explained in more detail below with reference to the accompanying drawings, in which:

FIG. 1 shows a first embodiment of the inventive apparatus;

FIG. 2 shows an enlarged representation of the buffer means for the embodiment shown in FIG. 1;

FIG. 3 shows a second preferred embodiment of the present invention;

FIG. 4 shows an enlarged representation of the buffer means for the embodiment shown in FIG. 3; and

FIGS. 5A-5C show a representation of a cutting machine in accordance with the prior art.

### DETAILED DESCRIPTION OF THE PREFERRED EMBODIMENTS

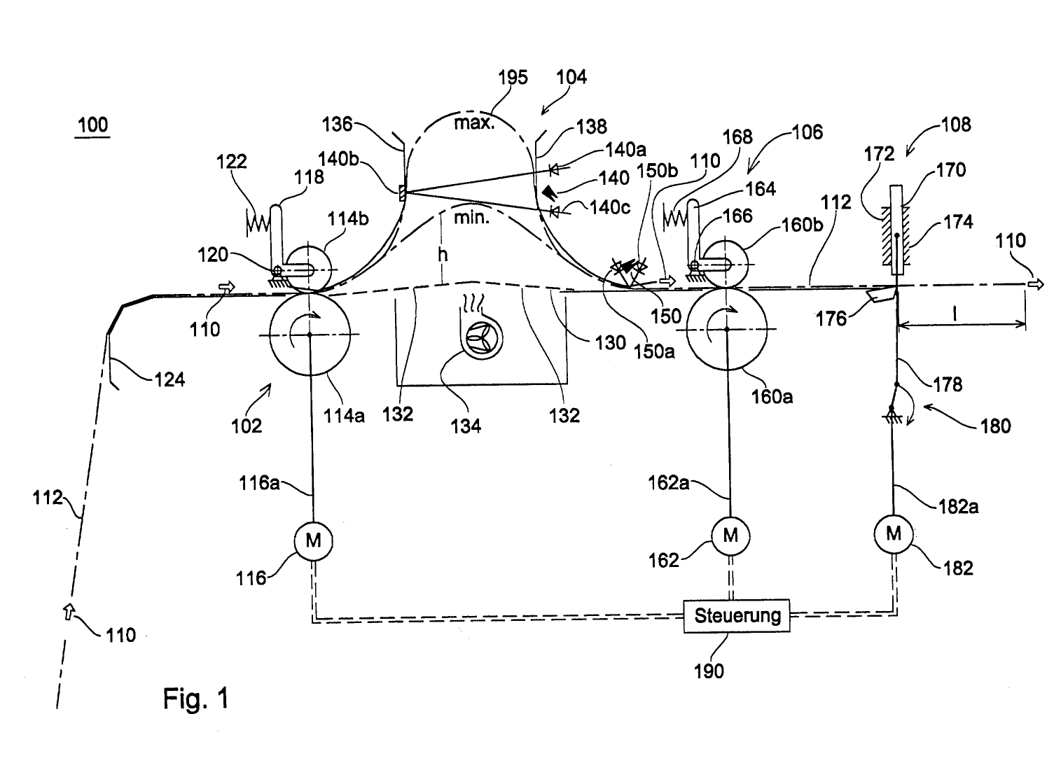

A first preferred embodiment of the present invention will be described in more detail below with reference to FIG. 1.

FIG. 1 shows the schematic representation of a cutting machine 100 in accordance with a first embodiment of the present invention. The cutting machine 100 includes a feeding means 102, a buffer means 104, a conveying means 106 as well as a cutting means 108, which are arranged in succession in a conveying direction, indicated by arrows 110, of the paper web 112.

The feeding means 102 includes a pair of drive rolls 114a, 114b. The drive roll 114a is driven by a motor 116, as is shown schematically by the connection 116a. The drive roll 114b is arranged at an “L”-shaped support element 118 rotatably mounted by a bearing 120. By means of a spring 122 the support element 118, and thus by means of the bearing 120 the drive roll 114b, is biased against the drive roll 114a and presses against same.

The paper web 112 is guided along between the drive rolls 114a and 114b, which paper web is driven by the two rolls 114a, 114b. The paper web 112 is fed from a paper supply (not represented), for example in the form of a pre-folded stack or of a roll, in the direction of the feeding means 102, same additionally comprising a baffle and guiding plate 124 for properly feeding the paper web 112 to the feeding means 102.

The buffer means 104 includes a floor plate 130 extending substantially from the feeding means 102 to the conveying means 106. In the area where the paper web is to be received in the buffer means, the floor plate comprises a plurality of openings 132 allowing the passage of air. In the embodiment represented in FIG. 1, the paper web rests on the floor plate 130 at least in the portions adjacent to the feeding means 102 and to the conveying means 106, and air, which is generated by a fan 134 arranged below the floor plate 130 in the area of the buffer means 104, passes through the openings 132. The floor plate 130 forms a lower guiding means of the buffer means.

In addition to the floor plate 130, the buffer means 104 includes a first upper guiding means 136 and a second upper guiding means 138 which may each be designed as guiding plates. The first guiding plate 136 extends from the buffer means 104 to the feeding means 102 and is bent in such a manner that the guiding plate 136 is arranged substantially perpendicularly to the conveying direction 110 of the paper web 112 in the area of the buffer means 104, and is arranged substantially in parallel with the conveying direction 110 in the area of the feeding means 102. Similarly, the guiding plate 138 extends from the buffer means 104 to the conveying means 106, the guiding plate 138 being bent in such a manner that it is arranged substantially perpendicularly to the paper conveying direction 110 in the area of the buffer means 104 and so that it is arranged in substantially in parallel with the conveying direction 110 of the paper web 112 in the area of the conveying means 106.

The buffer means 104 further includes a sensor means 140 which is formed, in the embodiment represented, by a light-emitting diode or a laser diode 140a arranged adjacent to the guiding plate 138. The diode 140a radiates light in the direction of the first guiding plate 136 and onto a reflecting element 140b arranged on same, which element reflects the light beam back to a detector 140c which is in turn arranged adjacent to the guiding plate 138. The sensor means 140 serves to determine a height of the loop forming in the buffer means 104, a minimum and a maximum loop height of the paper web building up being represented, by way of example, in FIG. 1. The sensor means 140 detects a height h of the paper loop 195 in the buffer means 104 and outputs a corresponding detection signal to the control 190. The “height” of the loop is the distance by which same extends in a direction which is perpendicular to a plane in which the paper web 112 is fed and cut.

FIG. 1 further shows a second sensor means 150 arranged between the buffer means 104 and the conveying means 106 and including a light-emitting element 150a, such as a laser diode or a light-emitting diode, and a detector element 150b. By means of this sensor means the presence of a paper web and/or of format recognition features which are arranged on same and serve to control the cutting means may be detected.

The conveying means 106 is formed by a pair of drive rolls 160a, 160b having a similar structure as the pair of drive rolls 114a, 114b. A motor 162 drives the roll 160a, as is shown schematically by the connection 162a. The drive roll 160b is arranged at an “L”-shaped support element 164 which is rotatably mounted at 166. The support element 164 and, therefore, the drive roll 160b are biased against the drive roll 160a by a spring 168. The paper web 112 moves along between the drive rolls 160a and 160b. The paper web is moved in the direction of the cutting machine 108 by the conveying means 106 which at the same time serves to stop the paper web 112 upon reaching a cutting position.

The cutting means 108, which is shown only schematically, includes a lifting knife 170 guided by two guiding means 172, 174. The paper web 112 is guided along between the knife 170 and a counterblade 176. The knife 170 is connected to an actuation means 180 via an operative connection 178, which actuation means 180 is in turn drivable via a motor 182, as is represented by the connection 182a.

The individual drive elements 116, 162 and 182 of the cutting apparatus 100 are controlled by a control means 190, this control means ensuring, on the one hand, that the paper web is advanced by the length l, which represents the desired cutting length, in the forward-feed phase, and that the cutting of the paper web is actuated thereafter. On the other hand the control means 190 ensures that the paper loop accumulated in the buffer means does not fall short of the minimum height by controlling the respective drive elements in a suitable manner.

A paper removal means, not shown in FIG. 1, arranged downstream of the cutting apparatus in the paper conveying direction, is also provided. The paper removal means includes, for example, a pair of drive rolls between which the paper, which has been cut, is guided.

During operation, feeding the paper web 112 into the machine 100, and advancing the paper web 112 in the machine, with a stop for cutting, is achieved by two separate drive units 102, 106, i.e. by the drive “inflow” having a motor, and by the drive “forward feed” having a motor.

The drive “inflow” 102 pulls the paper web 112 into the machine 100 and conveys the paper web 112 into a loop 195 in the buffer means 104. The loop forms between the loop deflector plates 136, 138, and when a maximum height of the loop has been reached, the control means 190 causes the drive “inflow” 102 to be stopped.

While the drive “forward feed” 106 feeds the paper web 112 forward by the cutting length l under the transverse cutting means 108 at a high acceleration and speed, the drive “inflow” 102 causes, at the same time, the feeding of the paper web into the loop 195 of the buffer means 104.

Preferably, the drive “forward feed” 106 is run at a higher maximum speed than the drive “inflow” 102, so that the loop 195 between the deflector plates 136, 138 is initially reduced. During the time the drive “forward feed” 106 delays the paper web so as to effect a cutting of the web 112, which has been advanced, the loop builds up again in the buffer means 104.

The advantage of this arrangement is that the high dynamics of the paper forward feed for cutting is limited substantially to the paper web stored in the loop. The fan 134 supports, from below, a uniform and steady loop formation and simultaneously damps the movement of the paper in the loop.

The drive regulation or drive control 190 prevents the height of the loop from falling short of a minimum while the paper web 112 is advanced by a cutting length l by the drive “forward feed” 106. Hereby, undesired stretching, and therefore, undesired banging noise, and an even less desired mechanical stress upon the paper web is safely avoided.

In accordance with a further embodiment of the present invention the control means 190 is further adapted not to exceed a maximum height upon reaching a maximum loop height, when the drive “forward feed” 106 is at a standstill, i.e. during cutting or when the cutting means 108 is stopped.

In continuous operation of the apparatus 100, i.e. in cyclical feeding-forward and cutting, the drive control 190 sets the pull-in speed such that a nearly constant speed of the incoming paper web 112 is achieved.

The advantage of the embodiment described in FIG. 1 is that it avoids, unlike the apparatuses known from the prior art, a complete stretching of the paper web during the forward-feed phase of the paper web 112, and thus avoids the disadvantages associated therewith. A further advantage is that, as can be seen, no additional stamp element or other stop element is provided, but that the paper delay required is effected by the conveying means 106, by means of which the paper is either delayed or stopped during the cutting process.

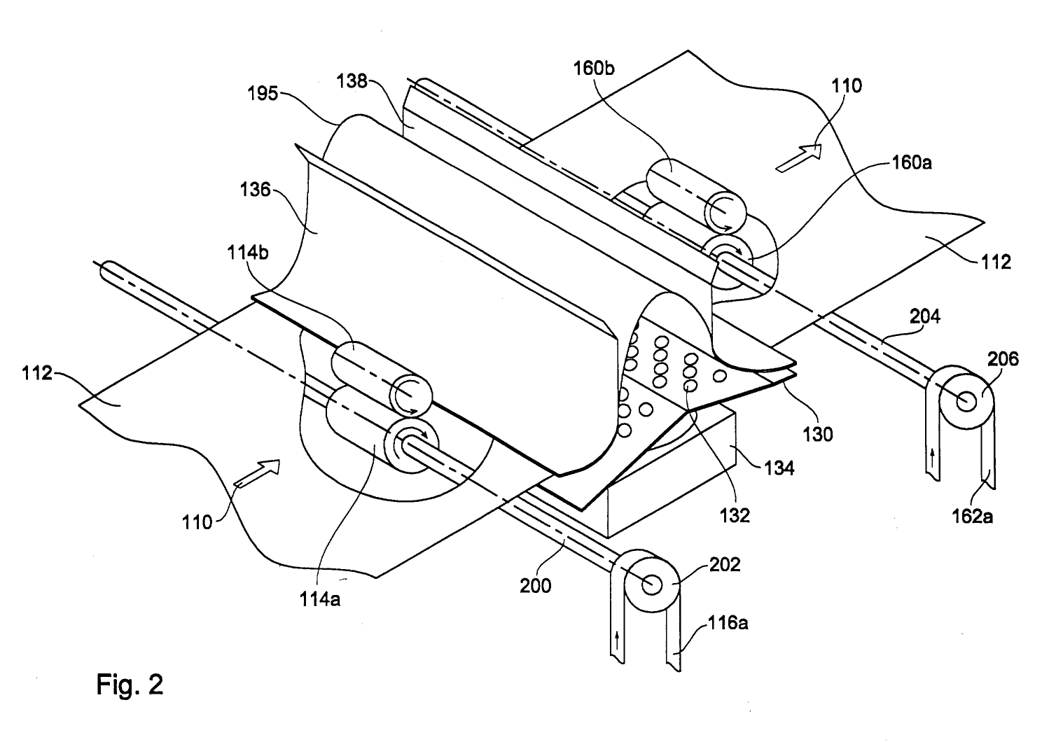

FIG. 2 is an enlarged representation of the buffer means. The conveying means 102 and 106 arranged immediately upstream and downstream of the buffer means are also represented. In FIG. 2, the elements that have already been described with reference to FIG. 1 have been given the same reference numerals, and a renewed description of same shall be omitted. As can be recognized, the drive roll 114a of the feeding means 102 is mounted on a shaft 200, upon which a belt wheel 202 is arranged. The wheel 202 is connected to the motor 116 (not shown in FIG. 2) via a belt 116a.

Similarly, the drive roll 160a of the conveying means 106 is arranged on a shaft 204 comprising a belt wheel 206 connected to the motor 162 (not represented) via a belt 162a.

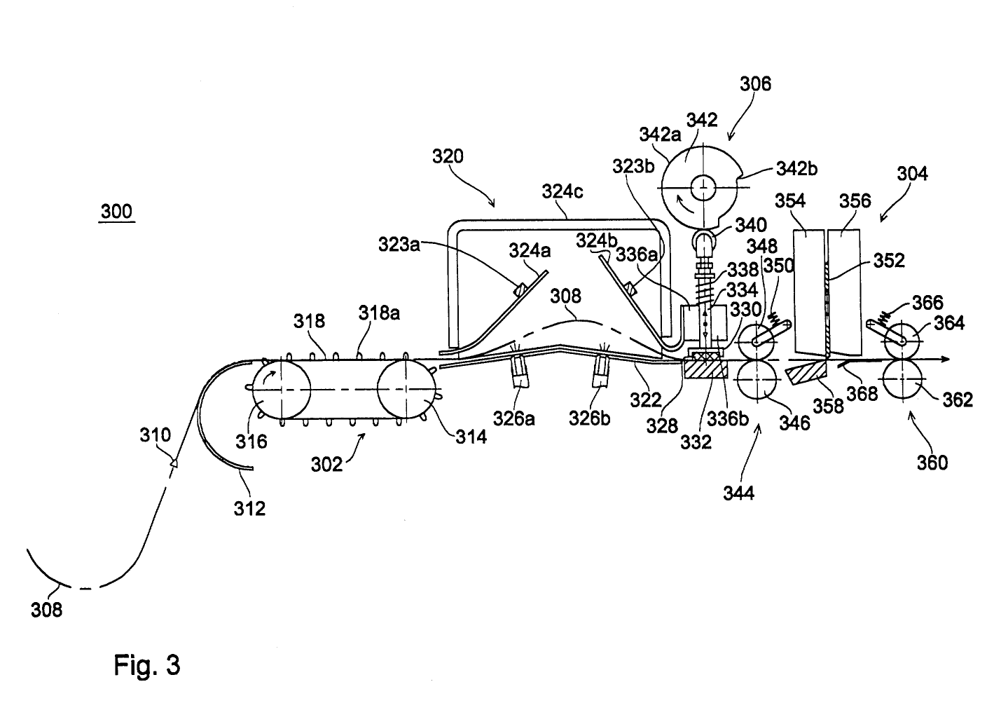

A further preferred embodiment of the inventive cutting machine will be represented below with reference to FIG. 3, which embodiment is similar to that of FIG. 1. Instead of the double action of the drive means 106 for conveying and delaying the paper web, this embodiment realizes this functionality in two separate means. Further the buffer means 104 additionally includes a hood so as to further support the damping of oscillations. The functionality of the buffer means and the control of the individual motors is similar to the embodiment shown in FIG. 1, so that it is ensured that the paper loop in the buffer 104 does not fall short of a minimum height.

The cutting machine 300 includes a feeding means 302, a cutting means 304 as well as a paper delay means 306 arranged between the feeding means 302 and the cutting means 304. The paper feeding means 302 feeds a paper web 308 at an substantially constant speed. The paper delay means 306 delays the feeding of the paper web 308 to the cutting means 304 in such a manner that a position is determined on the paper web 308 at which the cutting means 304 effects cutting of the paper web. The paper conveying direction is illustrated by the arrow 310.

The paper web 308 may be fed, for example, from a high-speed printer (not represented). Feeding is effected via a deflector and guiding means 312. In the embodiment shown in FIG. 3, the paper web 308 is provided with a perforated edge in which uniformly spaced holes are arranged by means of which the paper web is driven and guided. The feeding means 302 includes a drive roll 314, a guiding roll 316 as well as a feeding element 318 guided through the drive roll 314 and the guiding roll 316. The element 318 is provided with a plurality of teeth 318a which engage the holes arranged in the perforated edge of the paper web 308 and guide and drive the paper web 308 in this manner.

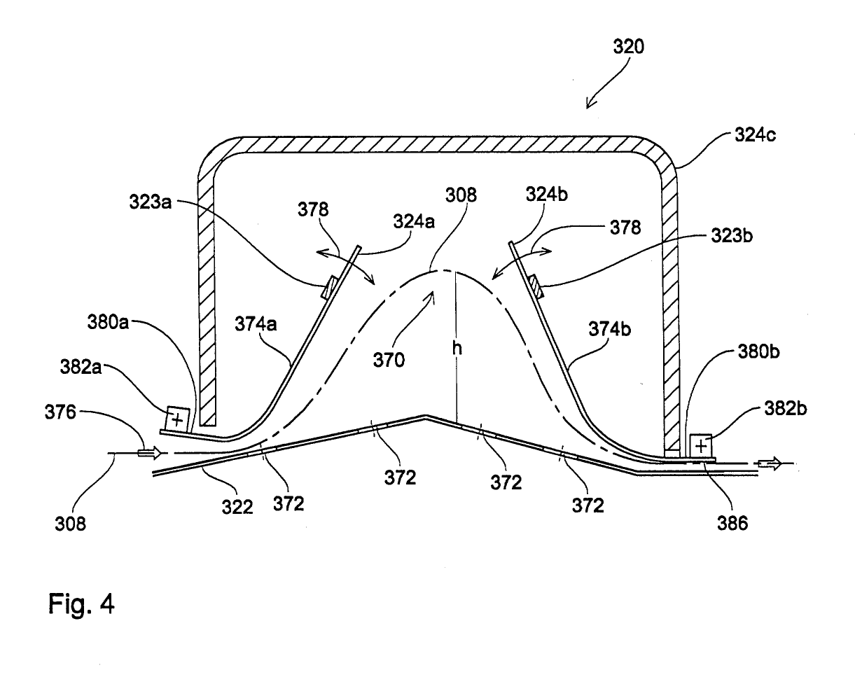

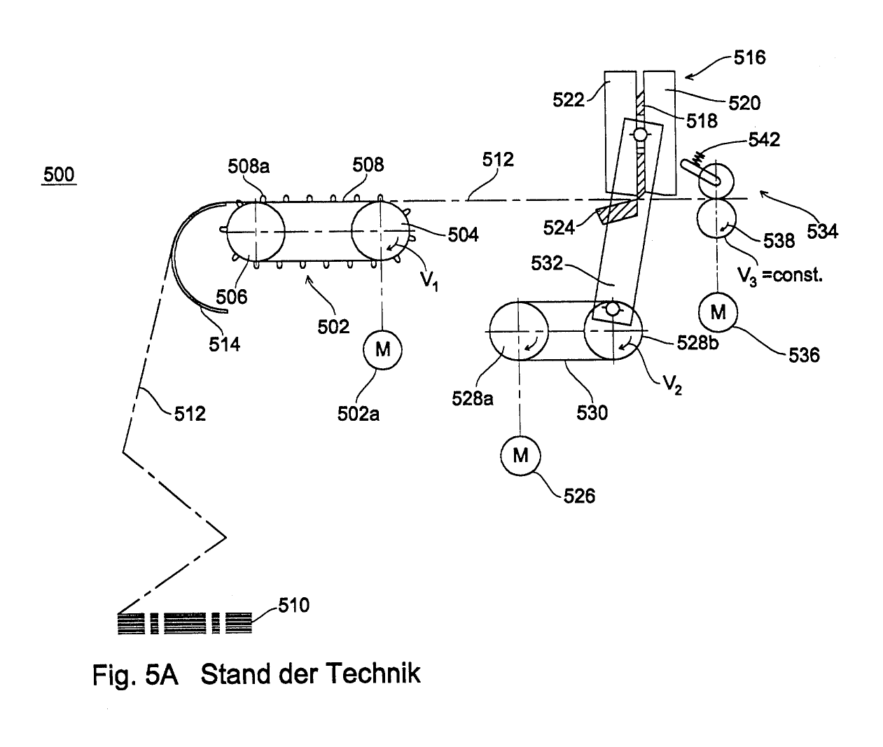

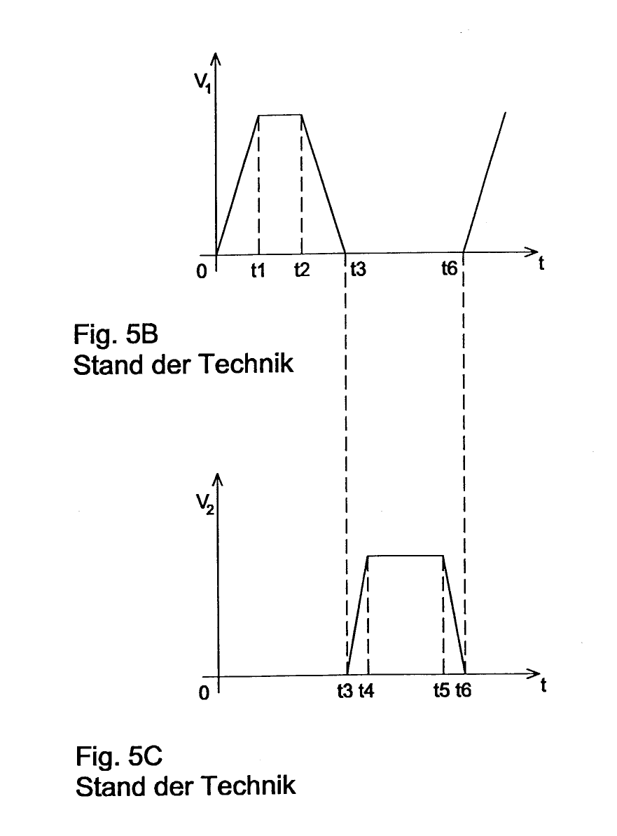

A buffer means 320 is provided between the feeding means 302. and the paper delay means 306, which buffer means 320 serves to receive the length of the paper web accumulating during the delay of the paper web caused by the delay means. An example of the buffer means will be described in more detail below with reference to FIG. 4.

The buffer means includes a lower guiding means 322, referred to as floor plate, and an upper guiding means consisting of two guiding plates 324a and 324b. The paper web 308 to be cut moves between the lower and the upper guiding means. Further the buffer means 320 includes a cover 324c. Two nozzles 326a, 326b are arranged at the lower feeding means 322, by which nozzles air preferably exits. The nozzles are provided for blowing air in between the paper web 308 and the lower guiding means 322 while the paper delay means 306 delays the conveyance of the paper web 308, so that the paper web 308 is lifted in a uniform manner without giving rise to any undesired warping or creasing of the paper web 308. The nozzles 326a, 326b may be controlled such that they are operative only while the delay means is activated and such that they are not activated while the paper web 308 moves through the delay means 306.

The functions of the lower and upper guiding means and of the hood will be described below with reference to FIG. 4, wherein same elements are designated by same reference numerals. A representation of the nozzles has been dispensed with in FIG. 4 so as to preserve the clarity of the representation.

The lower guiding means 322 is formed by a floor plate designed in an angled manner opposite the plane of the paper feeding so as to deflect the paper web 308, entering the buffer means 320, from the plane of the paper feeding, whereby the formation of a loop is effected. The floor plate 322 is provided with a plurality of recesses 372 by which air, emitted by the nozzles (FIG. 3, 326a and 326b), is introduced into the area between the floor plate 322 and the paper web 308. This supports the formation of the loop 370 in addition to the effect of the angled floor plate 322.

The upper feeding means 324 serves to ensure that, in the event that the paper web 308 abates against the upper guiding means 324 due to the air blown in, the paper web 308 may be safely guided to the paper delay means by the upper guiding means 324. The upper guiding means includes a first guiding plate 324a and a second guiding plate 324b. The guiding plates 324a, 324b each include a first portion 374a, 374b arranged at an angle with respect to the paper feeding direction (arrow 376). As is indicated by the arrows 378, the angle at which the first portions 374a, 374b are arranged is variable. Further, the guiding plates 324a, 324b each include a second portion 380a, 380b which extend substantially in parallel with the paper feeding direction 376 and are connected to the first portions 374a, 374b. The guiding plates 324a, 324b are attached, at the second portions 380a, 380b, to attachment means 382a, 382b. In accordance with one embodiment, the attachment means 382a, 382b are designed as lockable bearings so as to effect the angle adjustment of the first portions 374a, 374b. As can be seen in FIG. 4, the second portions 380a, 380b of the guiding plates 324a, 324b are arranged so as to form, together with the floor plate 322, an input portion 384 and an output portion 386 of the buffer means 320.

As is shown in FIG. 3, the second guiding plate 324b of the buffer means 320 may be attached, in accordance with another embodiment, to the one guiding means 336a of the paper delay means.

In the embodiment represented in FIG. 4, the cover 324c is attached to the second portions 380a, 380b of the guiding plates 324a, 324b. Hereby an air chamber 388 is formed wherein the oscillations occurring at high paper feeding speeds with loop formation are dampd. The cover 324c further serves for sound damping.

The buffer means 320 includes—as in the first embodiment—a sensor means formed by a light-emitting element 323a and a light-receiving element 323b. The element 323a is arranged adjacent to the guiding plate 324a and radiates light in the direction of the guiding plate 324b and onto the element 323b arranged on same. The sensor means 140 determines the height of the loop 370 forming in the buffer means 320.

Due to the above-described design of the buffer means 320, the behavior of the loop 370 at high paper feeding speeds, for example above 0.8 m/s, becomes reproducible, so that no negative influence on the cutting accuracy occurs. The tolerances of the cutting accuracy can therefore be met, and there are no incorrectly cut paper sheets.

In the following, reference is made again to FIG. 3. The paper delay means 306 includes a stamp member 328 held in a stamp member receiving means 330. The paper delay means 306 further includes a counter-stamp 332, the paper web 308 being guided along between the stamp 328 and the counter-stamp 332. The stamp 328 is connected to a piston 334 via the stamp member receiving means 330. The piston 334 is guided in a guiding means 336a, 336b. The piston 334 is biased by a spring 338 such that the spring force is operative so as to separate the stamp 328 from the counter-stamp 332. The piston is connected to a roll 340 at an end facing away from the stamp. The stamp, i.e. its movement against the counter-stamp 332 is actuated by means of a cam disk, or camshaft, 342, connected to the roll 340. The camshaft 342 includes a first part 342a causing the stamp 328 to be pressed against the counter-stamp 332 when the roll 340 is connected to this area 342a. If the roll 340 is in a second area 342b of the cam disk 342, the stamp 330 is separated from the counter-stamp 332 by the spring force exerted by the spring 338.

In other words, this means that the paper is delayed while the roll 340 is in the area 342a of the cam disk 342, and that no delay is exerted on the paper while the roll 340 is in the area 342b of the cam disk 342.

A guiding means 344 is arranged between the paper delay means 306 and the cutting means 304, the guiding means 344 comprising a drive roll 346 and a guiding roll 348, between which the paper web 308 is guided.

The guiding roll 348 is biased against the drive roll 346 by a spring 350. The transport speed of the guiding means 344 is several times the amount of the transport speed of the feeding means 302. This is to achieve that the loop accumulated during the delay process has been reduced again by the next clamping cycle, the height in the buffer means not being lower than the minimum height.

In the embodiment represented in FIG. 3 the cutting means 304 includes a falling knife 352 guided between two guiding means 354, 356. The knife 352 may be designed in the form of a guillotine knife and is arranged substantially perpendicularly to the paper conveying direction. The paper web 308 to be cut is guided between the knife 352 and a counterblade 358. The cutting machine 300 further includes a paper removal means 360 arranged downstream of the cutting apparatus 304 in the paper conveying direction. The paper removal means 360 includes a drive roll 362 and a guiding roll 364 between which the paper that has been cut is fed. The roll 364 is biased against the drive roll by means of a spring 366. In order to ensure that the paper that has been cut is guided safely from the cutting apparatus 304 to the paper removal means, a horizontal guiding means 368 is provided.

It is to be noted that the paper removal means 360 removes the paper at a higher speed than that at which it is fed by means of the feeding means 302. The speeds of the paper guiding means 344, 360 are about the same. This ensures that the papers that have been cut are removed safely from the cutting machine 300.

The paper web 308 may be printed upon on one or both sides, for example, by a printer means (not represented). In this case, the printer means is located upstream of the paper feeding means 302 in relation to the paper conveying direction.

The individual drive elements of the cutting apparatus 300 are controlled by a control means (not shown in FIG. 3), this control means ensuring, on the one hand, that the paper web is advanced by the desired cutting length in the forward-feed phase, and that the cutting of the paper web is actuated thereafter. On the other hand the control means ensures that the paper loop accumulated in the buffer means does not fall short of the minimum height by controlling the respective drive elements in a suitable manner. The sensor means detects a height h of the paper loop 370 (FIG. 4) in the buffer means 320 and outputs a corresponding detection signal to the control. The “height” of the loop is the distance by which same extends in one direction which is perpendicular to a plane in which the paper web is fed and cut.

In the embodiment represented in FIG. 3, the knife 352 arranged in the cutting apparatus 304 is a falling knife, for example. In case a falling knife is used, the paper delay means 306 is controlled such that the paper web 308 is completely stopped during the cutting due to the action of the stamp 328 upon the paper web 308.

In accordance with an embodiment of the present invention, a so-called format recognition means, as is known among those skilled in the art, may be arranged upstream of the paper feeding means in relation to the paper conveying direction. This format recognition means controls the respective drives of the paper feeding means, of the paper delay means and of the paper cutting means in such a manner that the cutting of the paper web is effected in accordance with the predetermined format.

Again in accordance with a further embodiment a detection means may be arranged adjacent to the paper delay means, which detection means detects predetermined markings on the paper web so as to control the paper delay means and the cutting means, depending on the detection of this marking, in such a manner that the paper web is cut in accordance with the predetermined format.

The detection means arranged adjacent to the delay means may be, for example, an optoelectronic converter which can detect the respective markings on the paper web.

In accordance with a further embodiment, the cutting machine may include a cutting apparatus which is implemented here as a rotary knife. The rotary knife includes a drum which has a blade attached to it. In one case the blade may be arranged at a fixed angular position of the drum and may exert, together with the counterblade, a shear action upon the paper web to be cut due to a corresponding shaping of the blade and of the counterblade, as is known among those skilled in the art. In this case is it necessary that the paper delay means fully stops the paper web during cutting.

A further implementation of the rotary knife may be such that the blade is not attached to a fixed angular position of the drum but extends steadily from a first angular position to a second angular position. It is further required that the paper delay means stops the paper web only for specifying the position where the step is to be performed, and subsequently enables the paper web to be moved along further at a speed adapted to the rotational speed of the rotary knife so that a cutting edge extending perpendicularly to the conveying direction of the paper web is established. The further conveyance of the paper web from the paper delay means to the cutting means is effected via the guiding means which ensures that the above-described speed is adapted to bring about the straight cut. A difference as compared with the feeding speed of the paper web into the cutting machine is compensated for by the buffer provided.

Several performance parameters of a cutting machine as has been described, for example, with reference to FIG. 3, will be given below.

The cutting machine 300 described with reference to FIG. 3 exhibits a performance of 24,000 cuts per hour, at dimensions of the resulting format of 304.8 mm×210 mm. This corresponds to about 7 cuts per second. The constant paper feeding speed amounts to 2.03 m/s with such a cutting machine.

Instead of the above-described knife drives, the knife of the cutting means may also be driven by a continuously driven motor with a subsequent switchable 1-tour clutch.

It is apparent to those skilled in the art that the present invention is not limited to the above-described embodiments. In fact it is also possible to implement the arrangement shown in FIG. 1 with the double-element solution known from FIG. 3 with regard to the delay means of the paper web. Similarly, a hood may be provided at the buffer means 104 in the embodiment set forth in FIG. 1 so as to further improve damping. Similarly, in the embodiment represented in FIG. 3, a conveying means as is used in the embodiment in FIG. 1 may be employed instead of the stamp.

Instead of the above-described sensors, other sensor arrangements with which those skilled in the art are familiar may also be used for detecting the loop height. It is also apparent for those skilled in the art that the components used in the above-described examples may be exchanged as required.

1. Apparatus for cutting paper webs, comprising:
a paper feeding means (102; 302);
a cutting means (108; 304);
a paper delay means (106; 306) which is arranged between the paper feeding means (102; 302) and the cutting means (108; 304) and delays the paper web (112; 308), which has been fed, in such a manner that a position where the cutting means (108; 304) cuts the paper web (112; 308) is determined on the paper web (112; 308);
a buffer means (104; 320) arranged between the paper feeding means (102; 302) and the paper delay means (106; 306) so as to receive, during the delay of the paper web (112; 308), an accumulating length of the paper web (112; 308) in the form of a loop; and
a control means (190),
characterized in that
the control means (190) controls the paper feeding means (102; 302) and the paper delay means (106; 306) such that the loop (195; 370) received in the buffer means (104; 320) does not fall short of a minimum height (h).

2. Apparatus as claimed in claim 1, characterized in that
the buffer means (104; 320) comprises a sensor (140; 323a, 323b) which detects the height (h) of the loop (195; 370) in the buffer means (104; 320), the control means (190) controlling the paper feeding means (102; 302) and the paper delay means (106; 306) depending on a detection signal of the sensor (140; 323a, 323b).

3. Apparatus as claimed in claim 1 or 2, characterized in that
the control means (190) controls the paper feeding means (102; 302) and the paper delay means (106; 306) in such a manner that the loop (195; 370) received in the buffer means (104; 320) does not exceed a maximum height (h).

4. Apparatus as claimed in any of claims 1 to 3, characterized in that
the paper delay means (106; 306) is a paper conveying means arranged between the buffer means (104; 320) and the cutting means (108; 304) and is controllable to stop or delay the paper web (112; 308).

5. Apparatus as claimed in claim 4, characterized in that the paper conveying means is formed by a pair of drive rolls (160a, 160b).

6. Apparatus as claimed in any of claims 1 to 4, characterized by
a fan means (134; 326a, 326b) which subjects the paper web (112; 308) in the area of the buffer means (104; 320) to an air flow so as to support the formation of the loop (195; 370) in the buffer means (104; 320).

7. Apparatus as claimed in claim 6, characterized in that the control means (190) controls the fan means (134; 326a, 326b).

8. Apparatus as claimed in any of claims 1 to 7, characterized in that
the paper delay means (306) comprises a stamp means acting upon the paper web (308).

9. Apparatus as claimed in any of claims 1 to 8, characterized in that
the buffer means (104; 320) includes means for guiding (132, 136, 138; 322, 324a, 324b) the paper web (112; 308) accumulated.

10. Apparatus as claimed in claim 9, characterized in that
the guiding means comprises a lower guiding means (132; 322) in the form of a lower plate in relation to the paper feeding direction, the lower plate including a plurality of recesses (132; 372).

11. Apparatus as claimed in claim 10, characterized in that
the guiding means includes an upper guiding means having a first guiding plate (136; 124a) and a second guiding plate (138; 124b), each comprising a first portion arranged under an angle with respect to the paper feeding direction (110; 310), and each comprising a second portion arranged substantially in parallel with the paper guiding direction (110; 310), the angle at which the first portions are arranged being adjustable.

12. Apparatus as claimed in any of claims 1 to 11, characterized in that
the buffer means (320) includes means for damping oscillations of the accumulated paper web (112; 308).

13. Apparatus as claimed in claim 12, characterized in that
the damping means is formed by a hood (324c) enclosing the guiding means (322, 324a, 324b) and forming an air chamber.

14. Apparatus as claimed in any of claims 1 to 13, characterized in that
the cutting means (108; 304) includes a falling knife arranged substantially perpendicularly to the paper web (112; 308) to be cut, or a rotary knife.

15. Apparatus as claimed in claim 14, characterized in that
the paper delay means (106; 306) fully stops the paper web (112; 308).

16. Apparatus as claimed in any of claims 1 to 15, characterized in that
the paper web (308) is provided with guiding perforations; and
the paper feeding means (302) includes a tractor means (318a) for guiding the paper web (308).

17. Apparatus as claimed in any of claims 1 to 16, characterized by
printer means arranged in the paper conveying direction upstream of the paper feeding means (102; 302) so as to print on the paper web (112; 308).

18. Apparatus as claimed in any of claims 1 to 17, characterized by
a paper removal means (360) arranged in the paper conveying direction downstream of the cutting means (304) so as to pass on the individual papers which have been cut, respectively.

19. Apparatus as claimed in claim 18, characterized in that
the paper removal means (360) removes the individual papers, which have been cut, at a higher speed than that at which the paper feeding means (302) feeds the paper web (308).

20. Apparatus as claimed in any of claims 1 to 19, characterized in that
a format recognition means is arranged in the paper conveying direction upstream of the paper feeding means (102; 302), the format recognition means controlling the respective drives of the paper feeding means (102; 302), of the paper delay means (106; 306) and of the cutting means (108; 304) in such a manner that the paper web (112; 308) is cut in accordance with a predetermined format.

21. Apparatus as claimed in any of claims 1 to 19, characterized in that
a detection means is arranged adjacent to the paper delay means (106; 306), the detection means detecting predetermined markings on the paper web (112; 308) so as to control the paper delay means (106; 306) and the cutting means (108; 304), depending on the detection of these markings, in such a manner that the paper web (112; 308) is cut in accordance with a predetermined format.

22. Apparatus as claimed in claim 21, characterized in that
the detection means detects an optoelectronic means.
